(19) United States
(12) Patent Application Publication
(10) Pub. No.: US 2012/0085684 A1
(43) Pub. Date: Apr. 12, 2012

(54) Method and Apparatus for Separating a Non-Ferous Metal-Comprising Fraction from Ferrous Scrap

(75) Inventors: Peter Carlo Rem, Rijswijk (NL); Simon Peter Maria Berkhout, Schipluiden (NL)

(73) Assignee: ReSteel B.V., Badhoevedorp (NL)

(21) Appl. No.: 13/268,146

(22) Filed: Oct. 7, 2011

Related U.S. Application Data
(63) Continuation of application No. PCT/NL2010/050186, filed on Apr. 7, 2010.

(30) Foreign Application Priority Data
Apr. 8, 2009 (NL) NL 2002730

(51) Int. Cl. B03C 1/30; B03B 5/68; B03C 1/16; B07C 5/00

(52) U.S. Cl. 209/39; 209/644

(57) ABSTRACT

Method for separating a non-ferrous metal-comprising fraction from ferrous scrap, wherein the ferrous scrap is conveyed to a processing device for separating the non-ferrous metal-comprising fraction from the remainder of the ferrous scrap. The processing device supplies a beam of water, and the ferrous scrap is conveyed and released into the waterbeam so as to cause that the ferrous scrap is allowed to fall and move further, subject to the forces of gravity and the waterbeam.

### CROSS-REFERENCE TO RELATED APPLICATIONS

This application is a continuation application of International Patent Application Serial No. PCT/NL2010/050186, entitled “Method and Apparatus for Separating a Non-Ferous Metal-Comprising Fraction from Ferrous Scrap”, to Technische Universiteit Delft, filed on Apr. 7, 2010, which is a continuation of Netherlands Patent Application Serial No. 2002730, entitled “Method and Apparatus for Separating a Non-Ferous Metal-Comprising Fraction from Ferrous Scrap”, to Technische Universiteit Delft, filed on Apr. 8, 2009, and the specifications and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field):

The present invention concerns both a method and an apparatus for separating a non-ferrous metal-comprising fraction from ferrous scrap, in particular from steel scrap that is produced from end of life consumer-products such as cars in car shredders, as well as electric and electronic appliances that are being recycled for their valuable materials. The non-ferrous metal fraction may for instance be a copper-comprising fraction, which usually originates from electrical coils or transformers. It may also concern other metals such as zinc, lead or cadmium. These metals are commonly used in batteries or other sources that unintentionally are mixed with the ferrous scrap.

2. Description of Related Art:

It is known from EP-A-I 878 505 to apply a separating device embodied with a magnet in a drum that supports a conveyor belt, for separating liberated ferrous scrap from non-liberated ferrous scrap from a mixture of both the liberated and the non-liberated ferrous scrap that is transported with said conveyor belt. The term “liberated ferrous scrap” refers to fragments which essentially do not contain materials other than iron or steel, whereas the term “non-liberated ferrous scrap” refers to scrap fragments containing also other materials, in particular copper.

There is a continuous quest for liberated ferrous scrap i.e. iron or steel-scrap essentially free from foreign materials such as copper, zinc, lead, aluminium or cadmium for introducing such scrap into the steel manufacturing process. In order to gualify as steel-scrap of sufficient quality the average copper content of such liberated ferrous scrap must be less than 0.2 weight % and preferably even less than 0.1 weight %. Similar limits apply in connection with other non-ferrous metals.

U.S. Pat. No. 6,138,833 relates to a system for employing a placer gold mining method. The system includes a transport pipe for a mixture of fluid and gold ore, having separator boxes connected to the transport pipe which are connected in series and spaced at a predetermined interval. The separator boxes each have a cross-sectional area that is greater than that of the transport pipe, and the flow rate may be reduced where the separator boxes are provided in proportion to the respective cross-sectional areas. As the flow rate decreases, the placer gold having the greatest specific gravity are first allowed to settle and the remainder having the next greater specific gravity are then allowed to settle, and so on.

### BRIEF SUMMARY OF THE INVENTION

The invention is concerned with separating a non-ferrous metal-comprising fraction from unsorted ferrous scrap in order to improve the suitability of the remainder of the scrap to be applied as feed-stock for the steel manufacturing process.

### BRIEF DESCRIPTION OF THE SEVERAL VIEWS OF THE DRAWINGS

The invention will hereinafter be further elucidated with reference to an exemplary embodiment and with reference to the attached schematic drawing.

In the drawings:

FIG. 1 shows an apparatus for separating non-liberated ferrous scrap from liberated scrap in accordance with a first aspect of the invention, and

FIG. 2 shows an apparatus for separating a non-ferrous metal-comprising fraction from ferrous scrap in accordance with a second aspect of the invention.

### DETAILED DESCRIPTION OF THE INVENTION

In order to address this objective the method and the apparatus of the invention are characterized by one or more of the appended claims.

In a first aspect of the invention use is made of a conveyor belt for moving a mixture of the non-liberated and the liberated ferrous scrap through a separation zone at which the conveyor belt is supported by a rotatable drum, whereby in said drum a magnet is provided inducing a magnetic field in the entirety of said separation zone with magnetic field lines that emerge radially from the drum in a first part of the separation zone, and that return radially to the drum in a second part of the separation zone, wherein the first part and the second part of the separation zone are distinct from and adjacent to each other and together form the separation zone.

The inventors have found this measure to appear best suited to meet the objective already expressed in EP-A-I 878 505 to have the magnetic field lines extend as much as possible parallel to the conveyor belt surface, as seen in the conveying direction of said conveyor belt.

Practice has shown that with this apparatus for separating the non-liberated ferrous scrap from the liberated ferrous scrap, the latter ferrous scrap can be purified up to a level that 75 volume % or 60 weight % of the original input of ferrous scrap can be graded into the category liberated ferrous scrap which is immediately usable as input for the steelmaking process. The remainder of 25 volume % corresponding to 40 weight % of the original input of ferrous scrap then remains as non-liberated ferrous scrap that requires further processing for separation of the non-ferrous metal-comprising fraction thereof.

It is thus a further objective of the invention to further separate the non-ferrous metal-comprising fraction from ferrous scrap, in particular from the ferrous scrap that qualifies as the non-liberated ferrous scrap resulting from the separation in the just-mentioned apparatus. It is however expressly remarked that the following discussion concerning the separation of a non-ferrous metal-comprising fraction from ferrous scrap is also applicable to a stream of ferrous scrap, which in general may come available from any other source and not necessarily from the separation that has been established between non-liberated ferrous scrap and liberated ferrous scrap as mentioned above.

In accordance with a second aspect of the invention therefore a method for separating a non-ferrous metal-comprising fraction from ferrous scrap is proposed, wherein the ferrous scrap is moved by a conveyor that supports said ferrous scrap to a processing device for separating the non-ferrous metal-comprising fraction from the remainder of the ferrous scrap. Said processing device supplies a beam of water that leaves the processing device in a substantially horizontal flow, and in this method the ferrous scrap is released from the conveyor and moved from outside the waterbeam into said waterbeam so as to cause that the ferrous scrap is allowed to fall and move further, subject to the forces of gravity and the waterbeam.

Surprisingly it has been shown that with this method an effective separation of the non-ferrous metal-comprising fraction from ferrous scrap can be obtained, which the inventors believe is caused by the fact that the non-ferrous metal-comprising fraction concerns parts that are different in shape and form then the remainder of the ferrous scrap which is essentially free from those parts. An explanation for this may be that the ferrous scrap is modified by the shredding process causing that the copper-comprising fraction gets enriched with parts having relatively more spherical shapes. For batteries forming a major source of zinc, cadmium and lead it is held that these parts already have partly spherical or at least a non-flat shape of their own, which differentiates these parts from the essentially flat ferrous scrap that forms the said remainder.

The method of the invention as just recited can be suitably carried out in an apparatus for separating a non-ferrous metal-comprising fraction from ferrous scrap. This apparatus comprises a processing device and a conveyor for supporting and moving the ferrous scrap to said processing device for separating the non-ferrous metal-comprising fraction from the remainder of the ferrous scrap, and the processing device comprises a fluid-outlet for a waterbeam at which fluid-outlet the waterbeam leaves the said outlet in a substantially horizontal flow, and the conveyor is arranged to release during operation the ferrous scrap from the conveyor and move said ferrous scrap from outside the waterbeam into this waterbeam so as to allow that the ferrous scrap falls and moves further, subject to the forces of gravity and the waterbeam.

It is then particularly desirable that the fluid outlet for the waterbeam is arranged under the conveyor for the ferrous scrap, and proximal to an outlet of said conveyor where the ferrous scrap is released into the waterbeam. The spherical, non-flat and heavier parts that are comprised in the ferrous scrap then fall through the waterbeam, whereas the remaining parts are carried with the waterbeam farther away from the fluid outlet for the waterbeam, thus effecting a separation between the non-ferrous metal-comprising fraction and the remainder fraction of the stream of ferrous scrap.

In order to make a clear distinction between the non-ferrous metal-comprising fraction and the remainder of the ferrous scrap it is then desirable that the apparatus comprises a first receiving area proximal to the processing device for receipt of the non-ferrous metal-comprising fraction, and at least one second receiving area distant from the processing device for receipt of the remainder of the ferrous scrap. When one applies more than one second receiving area it is possible to distinguish between several weight categories of the fragments of the remainder of the scrap.

It is established that for an effective operation of the apparatus in accordance with the method of the invention, the non-ferrous metal-comprising fraction preferably has more spherical or non-flat parts relative to the remainder of the ferrous scrap, and the said remainder of the ferrous scrap has relative to the non-ferrous metal-comprising fraction more non-spherical or flat parts.

As already mentioned the method and the apparatus of the invention can be applied to a stream of ferrous scrap irrespective of its origin. For the overall efficiency of the separation process it is however beneficial that the apparatus of the invention is placed behind a separating device for the separation of non-liberated ferrous scrap from liberated ferrous scrap as disclosed in EP-A-I 878 505, which document in its entirety is deemed inserted and incorporated herein.

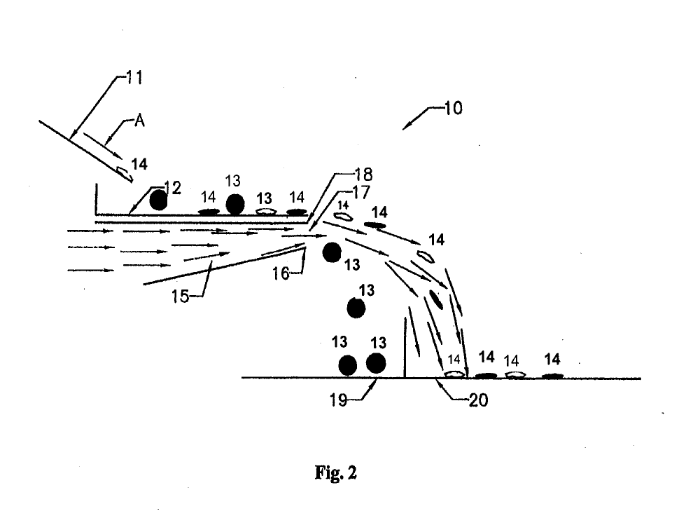

With reference to FIG. 1 an apparatus 1 is shown having a conveyor belt 4 for moving a mixture of non-liberated ferrous scrap and liberated ferrous scrap through a separation zone 6′, 6″ at which the conveyor belt 4 is supported by a rotatable drum 3. In said drum 3 a magnet 5 is provided that induces a magnetic field in the entirety of the separation zone 6′, 6″. The magnetic field lines 7 in said separation zone 6′, 6″ emerge radially from the drum 3 in a first part of 6′ of the separation zone 6′, 6″ and return radially to the drum 3 in a second part 6″ of the separation zone 6′, 6″, whereby the first part 6′ and the second part 6″ of the separation zone 6′, 6″ are distinct from each other and lie adjacent to each other and together form the complete separation zone 6′, 6″.

In accordance with a preferred embodiment of the invention the non-liberated ferrous scrap that is obtained by the operation of the apparatus 1 shown in FIG. 1 can be further upgraded and released from the non-ferrous metal-comprising fraction by the operation of the apparatus which is schematically shown in FIG. 2. It is however again expressly pointed out that the apparatus shown in FIG. 2 can also operate on feedstock originating from other sources than the apparatus shown in FIG. 1.

FIG. 2 schematically shows an apparatus 10 for separating a non-ferrous metal-comprising fraction 13 from ferrous scrap 13, 14 delivered to the apparatus 10 through a chute 11. The ferrous scrap 13, 14 enters the apparatus 10 through the chute 11 as symbolized with an arrow A and drops said scrap onto a conveyor 12.

The ferrous scrap 13, 14 that is moved by the conveyor 12 may have many different shapes and forms as symbolized with different scrap fragments 13 and 14. These scrap fragments 13, 14 are moved by the conveyor 12 to a processing device 15 for separating the non-ferrous metal-comprising fraction 13 from the remainder 14 of the ferrous scrap 13, 14. The non-ferrous metal-comprising fraction 13 has relative to the remainder 14 of the ferrous scrap more spherical and non-flat parts and the said remainder 14 of the ferrous scrap has relative to the non-ferrous metal-comprising fraction 13 more non-spherical or flat parts as symbolized by these fragments by the shapes shown in FIG. 2. The shape and form of the non-ferrous metal parts are partly due to the shredding process from which the stream of ferrous scrap originates, and which causes that particularly the copper-comprising fraction gets more spherical in shape. For metals such as zinc, lead and cadmium that originate from batteries, the shape is already non-flat to a degree that effective separation from the remainder of the ferrous scrap is possible.

The processing device 15 comprises a fluid outlet 16 for a waterbeam 17 and, as FIG. 2 shows, the waterbeam 17 flows during operation out of the processing device 15 essentially horizontally, and below and proximal to an outlet 18 of the conveyor 12 for the ferrous scrap 13, 14. As FIG. 2 illustrates, the conveyor 12 is arranged to release the ferrous scrap 13, 14 into the waterbeam 17 so as to allow that the ferrous scrap 13, 14 falls and moves further subject to the forces of gravity and the waterbeam. Due to the combined operation of the said forces exerted on the fragments 13, 14 of the ferrous scrap, a separation between the non-ferrous metal-comprising fraction 13 and the remainder 14 of the ferrous scrap is realized.

In order to secure the separation of the non-ferrous metal-comprising fraction 13 and the remainder 14 of the ferrous scrap, the apparatus 10 comprises a first receiving area 19 that is proximal to the processing device 15 for receipt therein of the non-ferrous metal-comprising fraction 13, and at least one second receiving area 20 distant from the processing device 15 and intended for receipt of the remainder 14 of the ferrous scrap.

For a proper operation of the apparatus 10 of the invention it has been established that the waterbeam 17 may be an approximately five centimeter thick waterbeam having a flow speed in the horizontal direction of approximately 1 m/s. It has been found that as compared to the prior art the apparatus 10 shown in FIG. 2 saves labor in an amount of two men that normally have to sort out by hand a stream of 20-25 ton per hour of ferrous scrap. Apart from the savings in labour the resulting quality of the separation allows that of the ferrous scrap from which the non-ferrous metal-comprising fraction 13 is removed, the remaining fraction 14 accounts for approximately 70% of the weight originally provided at the infeed section of the apparatus 10.

What is claimed is:

1. Method for separating a non-ferrous metal-comprising fraction from ferrous scrap, wherein the ferrous scrap is supported by a conveyor that moves said ferrous scrap to a processing device for separating the non-ferrous metal-comprising fraction from the remainder of the ferrous scrap, wherein the processing device supplies a beam of water leaving the processing device in a substantially horizontal flow below and proximal to an outlet of the conveyor for the ferrous scrap, and the ferrous scrap is released from the conveyor and moved from outside the waterbeam into said waterbeam so as to cause that the ferrous scrap is allowed to fall and move further, subject to the forces of gravity and the waterbeam, and the remaining parts are carried with the waterbeam, thus effecting a separation between the non-ferrous metal-comprising fraction and the remainder fraction of the stream of ferrous scrap.

2. Method according to claim 1, wherein the non-ferrous metal-comprising fraction has relative to the remainder of the ferrous scrap more spherical and non-flat parts, and the said remainder of the ferrous scrap has relative to the non-ferrous metal-comprising fraction more non-spherical or flat parts.

3. Method according to claim 1, wherein the non-ferrous metal-comprising fraction is received in a first receiving area proximal to the processing device, and the remainder of the ferrous scrap is received in one of a series of second receiving areas distant from the processing device.

4. Method according to claim 1, wherein the ferrous scrap that is conveyed to the processing device is non-liberated ferrous scrap resulting from the method disclosed in EP-A-1 878 505.

5. Method according to claim 4, wherein the non-liberated ferrous scrap is separated from liberated ferrous scrap by moving the non-liberated and liberated ferrous scrap on a conveyor belt through a separation zone at which zone the conveyor belt is supported by a rotatable drum, whereby in the drum a magnet is provided that provides a magnetic field having magnetic field lines that emerge radially from the drum in a first part of the separation zone, wherein the first part and the second part of the separation zone are distinct from and adjacent to each other and together form the separation zone.

6. Apparatus for separating a non-ferrous metal-comprising fraction from ferrous scrap comprising a processing device and a conveyor for supporting and moving the ferrous scrap to said processing device for separating the non-ferrous metal-comprising fraction from the remainder of the ferrous scrap, wherein the processing device comprises a fluid outlet for a waterbeam, which fluid outlet for the waterbeam is arranged under the conveyor for the ferrous scrap and proximal to an outlet of said conveyor where the ferrous scrap is released into the waterbeam, which fluid outlet is arranged to have the waterbeam leave the said outlet in a substantially horizontal flow, and the conveyor is arranged to release during operation the ferrous scrap from the conveyor and to move said ferrous scrap from outside the waterbeam into said waterbeam so as to allow the ferrous scrap to fall and move further, subject to the forces of gravity and the waterbeam, whereas the remaining parts are carried with the waterbeam farther away from the fluid outlet for the waterbeam, thus effecting a separation between the non-ferrous metal-comprising fraction and the remainder fraction of the stream of ferrous scrap.

7. Apparatus according to claim 6, further comprising a first receiving area proximal to the processing device for receipt of the non-ferrous metal-comprising fraction and at least one second receiving area distant from the processing device for receipt of the remainder of the ferrous scrap.

8. Apparatus according to claim 6, wherein said apparatus is placed behind a separating device for the separation of non-liberated ferrous scrap from liberated ferrous scrap as disclosed in EP-A-I 878 505.

9. Apparatus according to claim 8, wherein the conveyor for moving the ferrous scrap to the processing device for separating the non-ferrous metal-comprising fraction from the remainder of the ferrous scrap, is preceded by a conveyor belt for moving a mixture of the non-liberated and the liberated ferrous scrap through a separation zone at which the conveyor belt is supported by a rotatable drum, whereby in said drum a magnet is provided inducing a magnetic field in the entirety of said separation zone with magnetic field lines that emerge radially from the drum in a first part of the separation zone, and that return radially to the drum in a second part of the separation zone, wherein the first part and the second part of the separation zone are distinct from and adjacent to each other and together form the separation zone.
